(19) United States
(12) Patent Application Publication
(10) Pub. No.: US 2006/0159401 A1
(43) Pub. Date: Jul. 20, 2006

(54) Optical waveguide connection device, plug and plug connection for optical waveguides

(76) Inventors: Oliver Lapp, Wuppertal (DE); Keith D. Sullivan, Berlin (DE); Rainer M. Zimmer, Schalksmuhle (DE)

Correspondence Address: CORNING CABLE SYSTEMS LLC, P O BOX 489, HICKORY, NC, 28603, US

(21) Appl. No.: 11/316,223

(22) Filed: Dec. 22, 2005

(30) Foreign Application Priority Data
Dec. 22, 2004 (DE) 202004020043.0

(51) Int. Cl. G02B 6/38

(52) U.S. Cl. 385/55

(57) ABSTRACT

The invention relates to an optical waveguide connection device, a plug and a plug connection for optical waveguides. The optical waveguide connection device has a carrier element, in particular a panel, having couplings for the plugs of the optical waveguides and being of integral design with the carrier element. The plug according to the invention has a ferrule which is mounted in the plug housing in an unresilient manner.

This application claims the benefit of German Patent Application No. 202004020043.0, filed on Dec. 22, 2004.

### FIELD OF THE INVENTION

The invention relates to an optical waveguide connection device. Furthermore, the invention relates to a plug for optical waveguides and to a plug connection for optical waveguides.

### BACKGROUND OF THE INVENTION

Connection devices and/or distributor devices, such as are known from the product catalog “Zubehör für LWL-Kabelnetze” (Accessories for Fiberoptic Cable Networks), edition 2, pages 226 and 227, Year 2002, Corning Cable Systems GmbH & Co. KG, are used in distribution cabinets for fiberoptic cables. The optical waveguide distributor devices shown there are used in particular for handling optical waveguides prefabricated with plugs, such as patchcords or pigtails, said optical waveguide distributor devices having a panel on a front side, into which panel couplings are inserted depending on the plug type. The panel forms a carrier element for the couplings and is also referred to as a switchpanel or a patch panel.

The couplings known from the prior art which are accommodated in openings in a carrier element or panel of an optical waveguide connection device or an optical waveguide distributor device are of multi-part design, outer coupling halves of the couplings being connected to one another by means of welding. A centering bush is inserted into the outer coupling halves of the couplings known from the prior art prior to welding and serves the purpose of precisely aligning two plugs which are accommodated in the couplings. The optical waveguide connection devices known from the prior art or the couplings of said optical waveguide connection devices have a complex design and require a high degree of complexity in terms of assembly. The same applies to the plugs which are accommodated in the couplings.

Against this background, the present invention is based on the problem of providing a novel optical waveguide connection device, a novel plug for optical waveguides and a novel plug connection for optical waveguides.

This objective is achieved by an optical waveguide connection device wherein the or each coupling for the plugs of the optical waveguides is of integral design.

In the context of the present invention, an integral coupling is proposed for the plugs of preferably prefabricated optical waveguides, the or each coupling either being an integral component of a carrier element, in particular of a panel, or being in the form of a separate component and being latched into openings in the carrier element. With the present invention, the design of couplings and thus of optical waveguide connection devices can be considerably simplified compared to the prior art. The complexity in terms of assembly and the manufacturing costs are reduced as a result.

The or each coupling preferably has, on an inner side of the carrier element, a first coupling opening for the purpose of accommodating a centering bush and for the purpose of accommodating a plug, the centering bush being held in the first coupling opening by the plug. The or each coupling also has, on the inner side of the carrier element, latching elements which interact with latching elements on the plug in order to fix the centering bush and the plug in the first coupling opening.

The plug according to the invention is as shown and described herein. According to the invention, the ferrule is mounted in the plug housing in an unresilient manner, said ferrule being mounted in the plug housing in the manner of a ball joint for the purpose of compensating for tilted positions as a result of transverse forces acting on the plug.

The plug connection according to the invention for optical waveguides is likewise as shown and described herein.

Preferred embodiments of the invention are described in the detailed description below. The preferred embodiments of the invention will be explained in more detail, in a nonrestrictive manner, using the accompanying drawings, in which:

### BRIEF DESCRIPTION OF THE DRAWINGS

FIG. 1 shows a perspective view of an inner side of a panel of an optical waveguide distributor device according to the invention in accordance with a first preferred embodiment of the invention;

FIG. 2 shows a detailed view of a section from the panel in FIG. 1 in the region of a coupling as seen from the inner side of the panel;

FIG. 3 shows a detailed view of a section from the panel in FIG. 1 in the region of a coupling, as seen from the outer side of the panel;

FIG. 4 shows a front view of the section shown in FIG. 2;

FIG. 5 shows a cross section through the section shown in FIGS. 2 and 4, along the section line V-V in FIG. 4;

FIG. 6 shows a cross section through the section shown in FIGS. 2 and 4, along the section line VI-VI in FIG. 4;

FIG. 7 shows the section shown in FIG. 2 together with a plug and a centering bush;

FIG. 8 shows the arrangement in FIG. 7, in a perspective view as seen from the outer side of the panel;

FIG. 9 shows a cross section through the arrangement shown in FIGS. 7 and 8;

FIG. 10 shows a perspective view of an inner side of a panel of an optical waveguide distributor device according to the invention in accordance with a second preferred embodiment of the invention;

FIG. 11 shows a perspective view of a coupling of the arrangement shown in FIG. 10, as seen from the inner side of the panel;

FIG. 12 shows a further perspective view of the coupling shown in FIG. 11, as seen from the outer side of the panel;

FIG. 13 shows a cross section through a plug according to the invention in accordance with a first preferred embodiment of the invention for the optical waveguide distributor device shown in FIGS. 1 to 9 or the optical waveguide distributor device shown in FIGS. 10 to 12;

FIG. 14 shows a first exploded illustration of the plug according to the invention shown in FIG. 13;

FIG. 15 shows a second exploded illustration of the plug according to the invention shown in FIG. 13;

FIG. 16 shows a cross section through the plug shown in FIG. 13 which has been inserted into a coupling of a panel shown in FIG. 1 from an inner side of the panel;

FIG. 17 shows a cross section rotated through 90° in relation to FIG. 16;

FIG. 18 shows the arrangement shown in FIGS. 16 and 17 together with a prior-art plug which has been inserted into the coupling of the panel from the outer side of the panel;

FIG. 19 shows a cross section through a plug according to the invention in accordance with a second preferred embodiment of the invention for the optical waveguide distributor device shown in FIG. 1 or the optical waveguide distributor device shown in FIG. 10;

FIG. 20 shows a first exploded illustration of the plug according to the invention shown in FIG. 19;

FIG. 21 shows a second exploded illustration of the plug according to the invention shown in FIG. 19;

FIG. 22 shows a cross section through the plug shown in FIG. 19 which has been inserted into a coupling of the panel shown in FIG. 1 from an inner side of the panel;

FIG. 23 shows a cross section rotated through 90° in relation to FIG. 16;

FIG. 24 shows the arrangement shown in FIGS. 22 and 23 together with a prior-art plug which has been inserted into the coupling of the panel from the outer side of the panel;

FIG. 25 shows a cross section through a plug according to the invention in accordance with a third preferred embodiment of the invention for the optical waveguide distributor device shown in FIG. 1 or the optical waveguide distributor device shown in FIG. 10;

FIG. 26 shows a first exploded illustration of the plug according to the invention shown in FIG. 25;

FIG. 27 shows a second exploded illustration of the plug according to the invention shown in FIG. 25;

FIG. 28 shows a cross section through the plug shown in FIG. 25 which has been inserted into a coupling of the panel shown in FIG. 1 from an inner side of the panel;

FIG. 29 shows a cross section rotated through 90° in relation to FIG. 28; and

FIG. 30 shows the arrangement shown in FIG. 28 together with a prior-art plug which has been inserted into the coupling of the panel from the outer side of the panel.

### DETAILED DESCRIPTION OF THE PREFERRED EMBODIMENTS

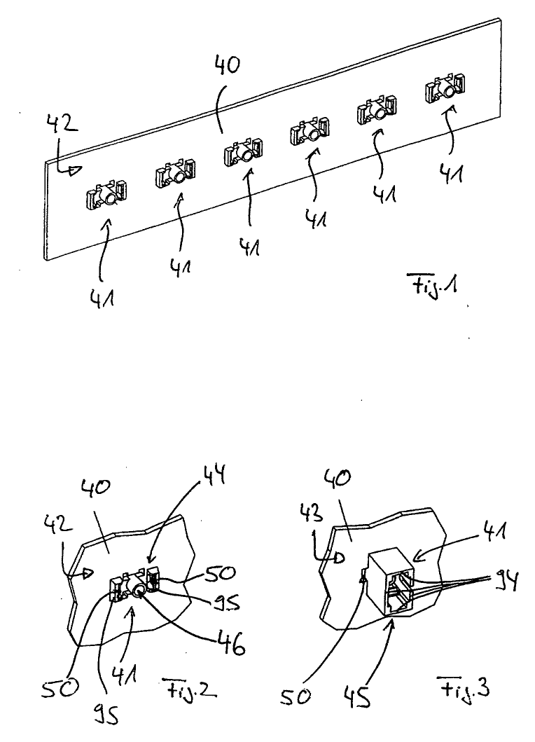

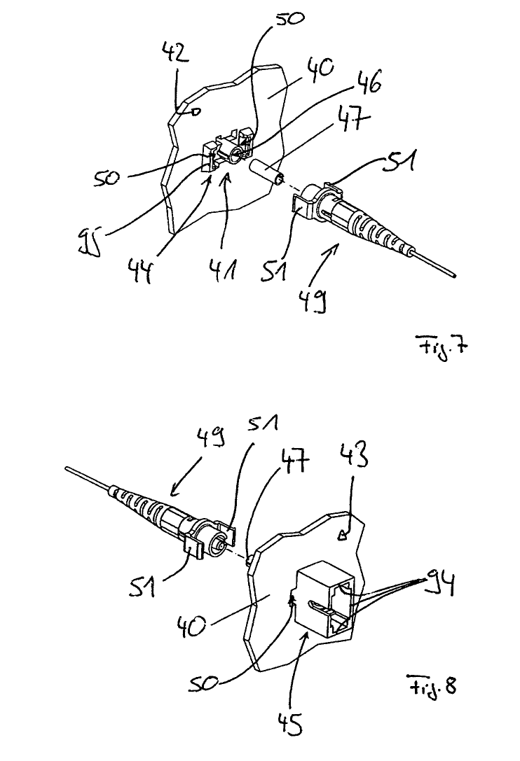

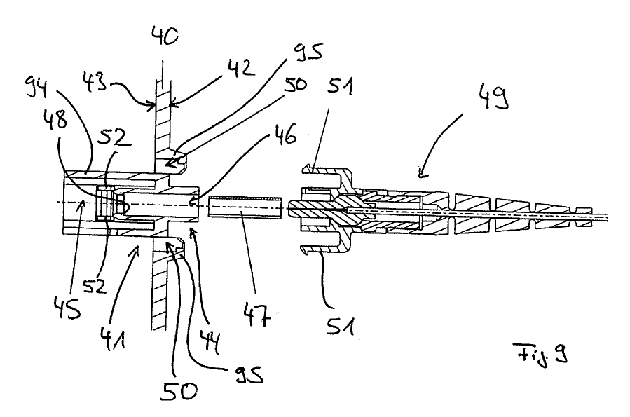

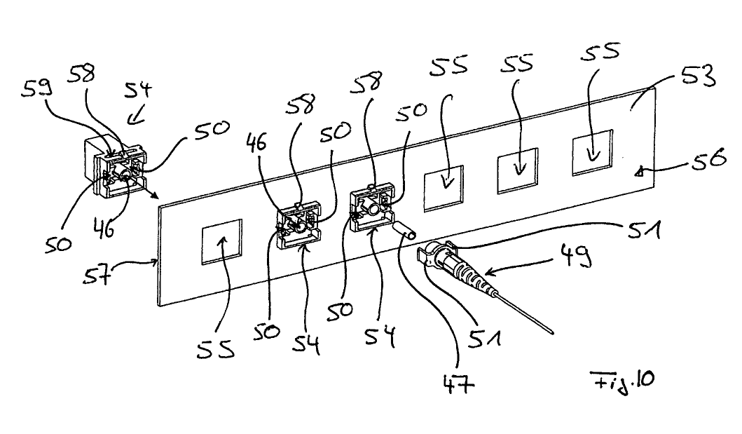

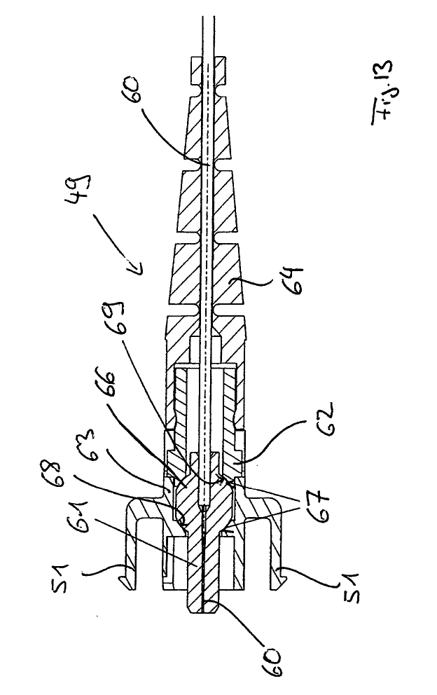

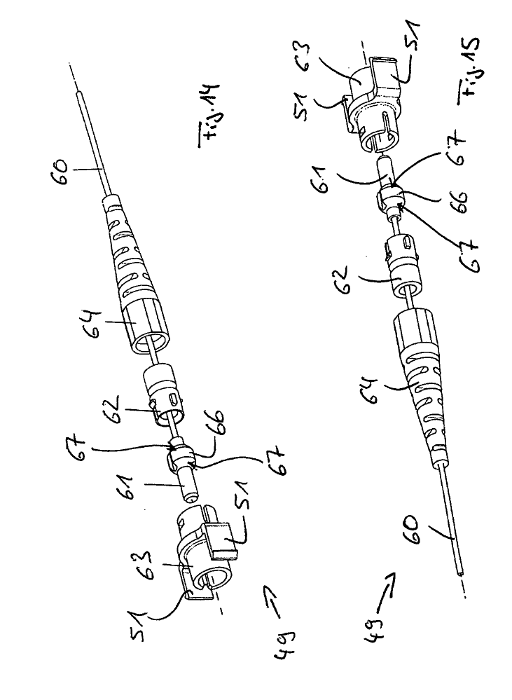

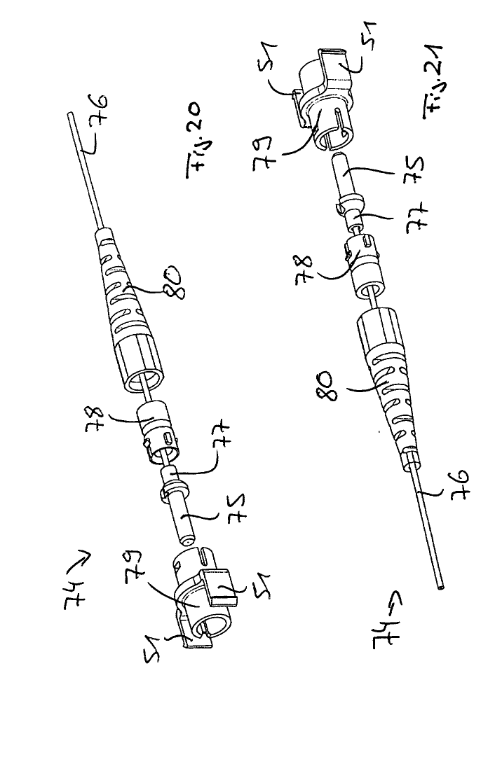

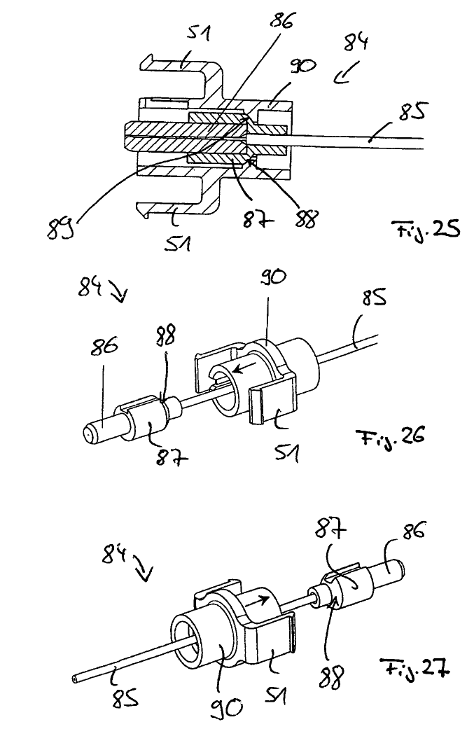

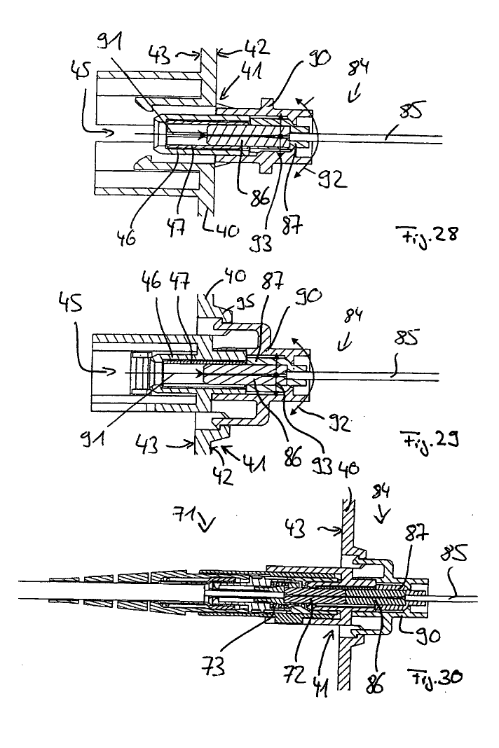

The present invention will be described in greater detail below with reference to FIGS. 1 to 30.

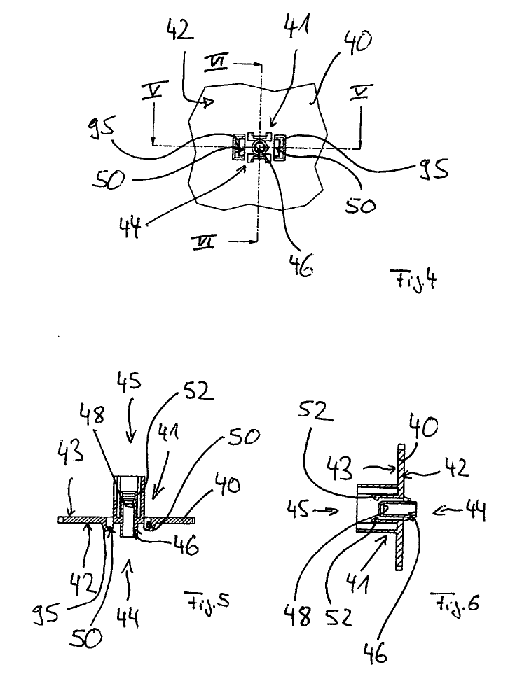

FIG. 1 shows a panel 40 of an optical waveguide distributor device according to the invention, in which case a panel is also referred to as a switchpanel or a patch panel. The panel 40 may form, for example, a front wall of an optical waveguide distributor device (not illustrated in detail). In total six couplings 41 are integrated in the panel 40 in FIG. 1. FIG. 2 shows a section of the panel 40 in FIG. 1 in the region of such a coupling 41, to be precise in a viewing direction towards an inner side 42 of the panel 40. FIG. 3 shows the section in FIG. 2 in the viewing direction towards an outer side 43 of the panel 40.

The couplings 41 of the panel 40 are of integral design in the context of the present invention. In the preffered embodiment shown in FIGS. 1 to 9, these couplings are furthermore an integral component of the panel 40, and accordingly the couplings 41 form, together with the panel 40, a monolithic unit. The couplings 41, together with the panel 40, may be in the form of an injection-molded part.

In each case a plug of an optical waveguide or fiberoptic cable can be inserted into the couplings 41 from both sides, i.e. both from the inner side 42 and from the outer side 43. The couplings 41 accordingly have two coupling openings, namely a first coupling opening 44 on the inner side 42 of the panel 40 and a second coupling opening 45 on the outer side 43 of said panel 40. A plug which has a design according to the invention and will be described in greater detail further below can be inserted into the first coupling opening 44 positioned on the inner side 42. The second coupling opening 45 in the region of the outer side 43 of the panel serves the purpose of accommodating a standard plug, and in the exemplary embodiments shown, a so-called SC plug.

The integral couplings 41 of the panel 40 have a receptacle 46 for a centering bush 47. The receptacle 46 is open in the region of the inner side 42 of the panel 40 and allows the centering bush 47 to be inserted into the receptacle 46 in an unimpeded manner on the inner side 42. In the region of the outer side 43 of the panel 40, the receptacle 46 is constricted and forms a stop 48 for the centering bush 47. As can be seen in FIGS. 7 to 9, the centering bush 47 is inserted into the receptacle 46 before a plug 49 having a design according to the invention is inserted into the first coupling opening 44 in the coupling 41, the first coupling opening 44 being formed on the inner side 42 of the panel 40. Then, the plug 49 is inserted into the first coupling opening 44 and latched to the coupling 41, which results in the centering bush 47, on the one hand, and the plug 49, on the other hand, being fixed in the region of the coupling 41.

In order to fix the plug 49 to the inner side 42 of the panel 40 in the region of a coupling 41, the couplings 41 have latching elements 50 which interact with latching elements 51 on the plug 49. The latching elements 51 on the plug 49 are in the form of barb-like anchoring elements which snap into the latching elements 50, in the form of openings or recesses, on the inner side 42 of the panel 40. As can be seen in particular in FIGS. 5, 6 and 9, the latching elements 50 and 51 for fixing the plug 49 and thus the centering bush 47 to the inner side 42 of the panel 40 are located outside a coupling region for the standard plug on the outer side 43 of the panel 40. The coupling region for an SC standard plug is defined by latching elements 52 and guides 94. The latching elements 50 in the form of openings or recesses are accordingly located laterally next to the latching elements 52 and guides 94 for the standard plug.

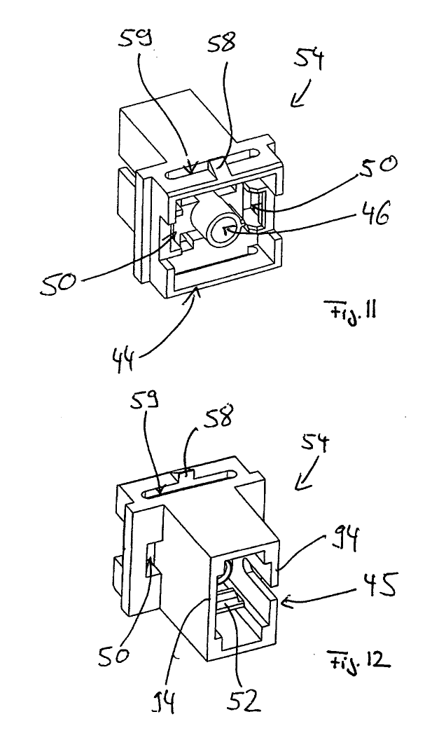

As has already been mentioned, the couplings 41 are an integral component of the panel 40 in the preferred embodiment shown in FIGS. 1 to 9. In contrast to this, FIGS. 10 to 12 show a panel 53 of an optical waveguide distributor device according to the invention in which couplings 54 are latched into openings 55 within a panel 53. The couplings 54 are in turn of integral design and form the first coupling opening 44 in the region of an inner side 56 of the panel 53 and the second coupling opening 45 in the region of an outer side 57 of the panel 53. The couplings 54 shown in FIGS. 10 to 12 correspond in terms of their design and operation to the couplings 41 shown in FIGS. 1 to 9, with the result that the same references are used for identical components in order to avoid unnecessary repetition.

The only difference, as mentioned above, consists in the fact that, in the preferred embodiment shown in FIGS. 10 to 12, the couplings 54 are latched into openings 55 within the panel 53, the couplings 54 having latching protrusions 58 for this purpose which snap into the panel 53 in the manner of barbs when the couplings 54 are inserted into the openings 55 in the panel 53. In order to ensure this snap-in movement, cutouts 59 are integrated in the couplings 54 adjacent to the latching protrusions 58, the cutouts 59 making it possible for the latching protrusions 58 to be elastically deformed in the direction of the above-described snap-in movement.

A first preferred embodiment of a plug 49 (already shown in FIGS. 7, 8, 9 and 10) provided on an optical waveguide 60 will be described below with reference to FIGS. 13 to 18.

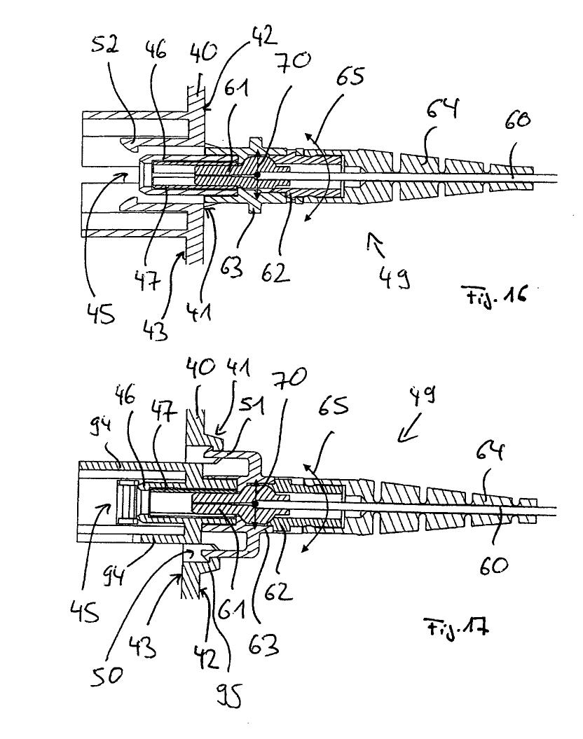

A ferrule 61 is associated with a free end of the optical waveguide 60, the optical waveguide 60 having its protective sleeve removed in the region of the ferrule 61 and thus being unsheathed. In the preferred embodiment shown in FIGS. 13 to 18, the plug 49 comprises, in addition to the ferrule 61 which is associated with the free end of the optical waveguide 60, an opposing ferrule bearing 62, a plug housing 63 and an anti-kink sleeve 64. In this case, in the context of the present invention, the ferrule 61 of the optical waveguide 60 is mounted in the plug housing 63 in an unresilient or unsprung manner. The ferrule 61 is mounted in the plug housing 63 in the manner of a ball joint for the purpose of compensating for inclined positions as a result of transverse forces acting on the plug 49. The transverse forces acting on the plug 49 are illustrated in FIGS. 16 and 17 by the double-headed arrow 65.

In the exemplary embodiment shown in FIGS. 13 to 18, the ferrule 61 is mounted in the plug housing 63 in the manner of a ball joint owing to the fact that the ferrule 61 has a thicker section 66, the thicker section 66 forming two dome-shaped surfaces 67. The two dome-shaped surfaces 67 of the thicker section 66 of the ferrule 61 interact with two surfaces having a complementary curvature, namely with a first surface 68, having a complementary curvature, of the plug housing 63 and a second surface 69, having a complementary curvature, of the opposing ferrule bearing 62. In this manner, the ferrule 61 is mounted both on the plug housing 63 and on the opposing ferrule bearing 62 of the plug 49 in the manner of a ball joint. If, in the case of a plug 49 inserted into a coupling 41, transverse forces act on said plug in the direction of the double-headed arrow 65 (cf. FIGS. 16 and 17), the ferrule 61 can carry out a slight pivoting movement owing to the fact that it is mounted in the manner of a ball joint or in the form of a dome. In this case, a sidewards movement of the ferrule 61 results, illustrated by the double-headed arrow 70, and this sideways movement can be compensated for by the play between the centering bush 47 and the receptacle 46 for the centering bush 47. The centering bush 47 has a slot in the longitudinal direction, as can be seen in particular in FIG. 16.

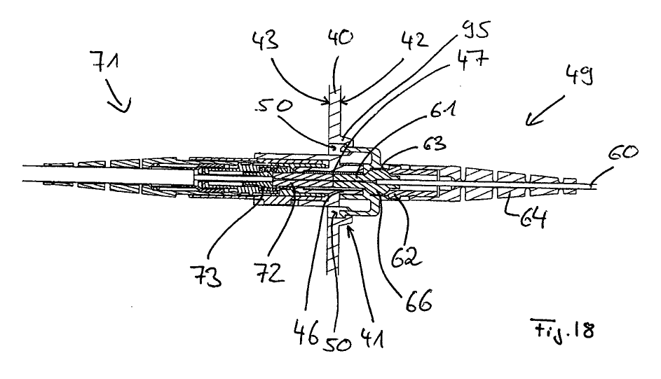

FIG. 18 shows the plug 49 shown in FIGS. 13 to 17 in a position in which it has been inserted into the coupling 41 from the inner side 42 of the panel 40, together with a standard plug 71 which has been inserted from the outer side 43 of the panel 40. The standard plug 71 in FIG. 18 is a so-called SC plug, in which a ferrule 72 is mounted in a resilient manner via a spring element 73. The design of the standard plug 71 is customary to those skilled in this art and therefore does not need any more detailed explanation. In the assembly position shown in FIG. 18, in which both the plug 49 according to the invention and the standard plug 41 have been inserted into a coupling 41 of the panel 40 of an optical waveguide distributor device according to the invention, the two ferrules 61 and 72 of the two plugs 49 and 71 are guided in the centering bush 47, the spring element 72 of the standard plug 71 pressing the ferrule 72 of the standard plug 71 against the ferrule 61 of the plug 49 according to the invention and thus the dome-shaped surface 67 of the ferrule 61 against the surface 69, having a complementary curvature, of the opposing ferrule bearing 62. As a result, the two ferrules 61 and 72 of the two plugs 49 and 71 are aligned precisely with respect to one another in order to thus position the optical waveguides guided in the ferrules precisely with respect to one another for the purpose of ensuring minimum damping attenuation.

As can be seen in particular in FIG. 13, a free end of the ferrule 61 protrudes with respect to the latching elements 51 of the plug housing 63. This ensures that the ferrule 61 of the ready-assembled plug 49 can be treated by means of grinding, for example. In order nevertheless to make it possible for the latching elements 51 of the plug housing 63 to latch, in the manner of barbs, into the latching elements 50, in the form of openings, of the panel 40, the panel 40 has, on the inner side 42, projections 95 which, together with the latching element 51 of the plug housing 63, ensure the latching connection between the coupling 41 or panel 40 and the plug 49.

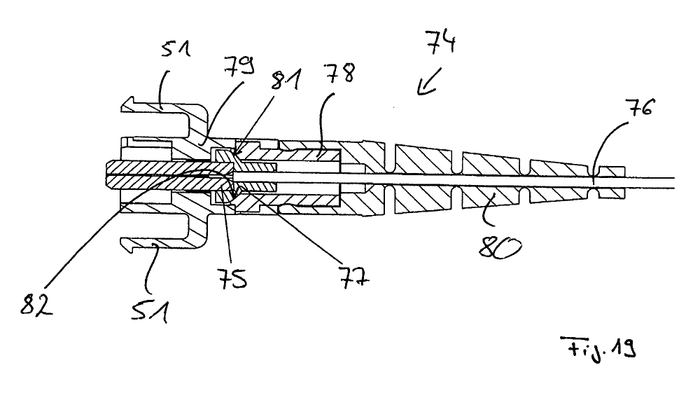

A second preferred embodiment of a plug 47 according to the invention is shown in FIGS. 19 to 24. This plug 47 in turn has a ferrule 75 for an optical waveguide 76, the ferrule 75 of the plug of the preferred embodiment shown in FIGS. 19 to 24 being in the form of a cylindrical standard ferrule. The ferrule 75 of the plug 47 is accommodated in a ferrule holder 77, the ferrule 75 being mounted in an unsprung manner and in the manner of a ball joint via the ferrule holder 77 in an opposing ferrule bearing 78 of the plug 74. Further components of the plug 74 of the exemplary embodiment shown in FIGS. 19 to 24 are in turn a plug housing 79 and an anti-kink sleeve 80, the plug housing 79 and the anti-kink sleeve 80 of the plug 74 shown in FIGS. 19 to 24 corresponding to the plug housing 63 and the anti-kink sleeve 64 of the plug 49 shown in FIGS. 13 to 18.

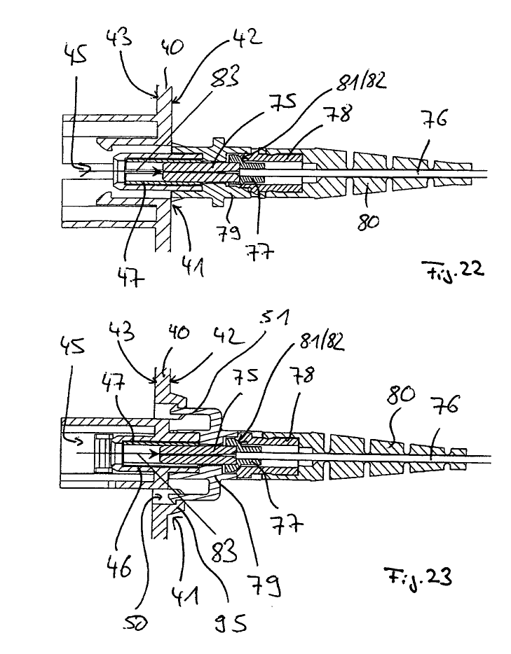

In the preferred embodiment shown in FIGS. 19 to 24, the ferrule holder 47 has a dome-shaped surface 81 which interacts with a surface 82, having a complementary curvature, of the opposing ferrule bearing 78 and provides a means of mounting the ferrule 75 in the manner of a ball joint. In the case of the plug 74 of the preferred embodiment shown in FIGS. 19 to 24, there is only one dome-shaped bearing point in the region of a rear side of the ferrule 75 in contrast to the plug 49 of the preferred embodiment shown in FIGS. 13 to 18. In the state in which the plug 74 has been inserted into the first coupling opening 44 in the coupling 41 of the panel 40 from the inner side 42 and a standard plug 71 has been inserted into the second coupling opening 45 from the outer side 43, the spring element 73 of the standard plug 71 presses the ferrule 72 of the standard plug 71 in the direction of the arrow 83 (cf. FIGS. 22 and 23) against the ferrule 75 of the plug 74 according to the invention and thus the ferrule holder 77 against the opposing ferrule bearing 78. Reference can be made to the embodiments relating to the plug 49 as regards the remaining details and operation of the plug 74.

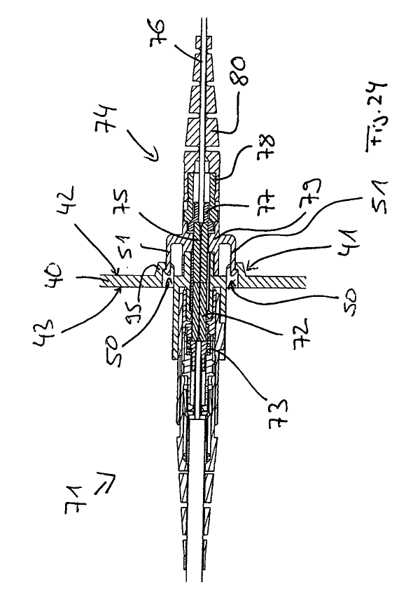

One further preferred embodiment of a plug 84 according to the invention for an optical waveguide 85 is shown in FIGS. 25 to 30. In turn, a ferrule 86 is associated with the optical waveguide 85, is in the form of a cylindrical standard ferrule and is accommodated in a ferrule holder 87. The ferrule 86 is in turn mounted in the plug 84 in an unsprung manner and in the manner of a ball joint, a dome-shaped surface 88 of the ferrule holder 87 interacting with a surface 89, having a complementary curvature, of a plug housing 90 and ensuring that the ferrule 86 is mounted in the manner of a ball joint.

FIGS. 28 to 30 show the plug 84 in a position in which it has been inserted into the first coupling opening 44 in a coupling 41 from the inner side 42 of the panel 40. In this position, the plug 84 in turn fixes the centering bush 47 in the receptacle 46 of the coupling 41.

In FIG. 30, the standard plug 71 has been inserted into the second coupling opening 45 in the coupling 41 from the outer side 43, the spring element 73 of the standard plug 71 pressing the ferrule 72 of the standard plug 71 in the direction of the arrow 91 against the ferrule 86 of the plug 84. This in turn results in the dome-shaped surface 88 of the ferrule holder 87 coming to bear against the surface 89, having a complementary curvature, of the plug housing 90. In turn, inclined positions as a result of transverse forces acting on the plug 84 in the direction of the double-headed arrow 92 can be compensated for since the ferrule 86 can carry out a sidewards movement in the direction of the double-headed arrow 93.

All of the plugs 49, 47 and 84 according to the invention accordingly have a ferrule which is mounted in an unsprung manner and in the manner of a ball joint. The plugs differ from one another only as regards the number of their components, the plug 84 of the exemplary embodiment shown in FIGS. 25 to 30 having the lowest number of components and thus having the simplest design.

Although the invention has been described with reference to FIGS. 1 to 30 using the example of optical waveguide distributor devices, reference will be made to the fact that the plug-connection technology according to the invention can also be used for optical waveguide connection devices. An example of such an optical waveguide connection device is in this case a junction box.

That which is claimed:

1. An optical waveguide connection device for optical waveguides provided with opposing plugs, the connector device having a carrier element comprising at least one coupling, the coupling for the plugs of the optical waveguides being of integral design with the carrier element.

2. An optical waveguide connection device according to claim 1, wherein the coupling is an integral component of the carrier element.

3. An optical waveguide connection device according to claim 1, wherein the coupling is in the form of a separate component and is latched into an opening in the carrier element.

4. An optical waveguide connection device according to claim 1, wherein the coupling is in the form of an injection-molded part.

5. An optical waveguide connection device according to claim 1, wherein the coupling has a first coupling opening on an inner side of the carrier element for accommodating a centering bush and for accommodating a plug provided on an optical waveguide, the centering bush being held in the first coupling opening by the plug.

6. An optical waveguide connection device according to claim 5, wherein the coupling has a second coupling opening on an outer side of the carrier element for accommodating a standard plug.

7. An optical waveguide connection device according to claim 5, wherein the coupling has latching elements on the inner side of the carrier element which interact with latching elements on the plug of the optical waveguide in order to fix the centering bush and the plug in the first coupling opening.

8. An optical waveguide connection device according to claim 7, wherein the latching elements are located outside a coupling region of the second coupling opening for accommodating the standard plug.

9. An optical waveguide connection device according to claim 5, wherein the or each coupling has a receptacle for the centering bush, the receptacle permitting a free movement of the centering bush on the inner side of the carrier element or in the region of the first coupling opening and forming a stop for the centering bush on the outer side of the carrier element or in the region of the second coupling opening.

10. An optical waveguide connection device according to claim 1, wherein the coupling is formed on the inner side of the carrier element such that the coupling serves the purpose of accommodating a standard plug.

11. A plug for optical waveguides having a plug housing for accommodating an optical waveguide provided with a ferrule, wherein the ferrule is mounted in the plug housing in an unresilient manner.

12. A plug according to claim 11, wherein the ferrule is mounted in the plug housing in the manner of a ball joint for the purpose of compensating for tilted positions as a result of transverse forces acting on the plug.

13. A plug according to claim 11, wherein the ferrule has at least one dome-shaped surface which, with a surface of the plug housing having a complementary curvature, provides a means of mounting the ferrule in the manner of a ball joint.

14. A plug according to claim 13, wherein the ferrule has two dome-shaped surfaces which, with a surface of the plug housing having a complementary curvature, provide a means of mounting the ferrule in the manner of a ball joint.

15. A plug according to claim 13, wherein the ferrule holder has a dome-shaped surface which, with a surface of an opposing ferrule bearing having a complementary curvature, provides a means of mounting the ferrule in the manner of a ball joint.

16. A plug according to claim 13, wherein the ferrule holder has a dome-shaped surface which, with a surface of the plug housing having a complementary curvature, provides a means of mounting the ferrule in the manner of a ball joint.

17. A plug according to claim 11, wherein the plug housing has latching elements which interact with latching elements on a coupling of an optical waveguide connection device in order to fix the plug to the optical waveguide connection device.
